(19) United States
(12) Patent Application Publication
(10) Pub. No.: US 2017/0150696 A1
(43) Pub. Date: Jun. 1, 2017

(54) Litter Bowl and Scoop

(71) Applicant: Prichard Ray Products, LLC, Hollister, MO (US)

(72) Inventor: Thomas Prichard Ray Christian, Hollister, MO (US)

(21) Appl. No.: 15/268,351

(22) Filed: Sep. 16, 2016

Related U.S. Application Data
(60) Provisional application No. 62/260,303, filed on Nov. 26, 2015.

(51) Int. Cl. A01K 1/01; A01K 1/015

(52) U.S. Cl. CPC A01K 1/0114; A01K 1/0157

(57) ABSTRACT

A litter receptacle assembly comprises a litter receptacle including a concave arcuate surface and a litter scoop including a scoop portion and a handle portion, wherein the scoop portion includes a bottom wall including a front scoop edge having a convex arcuate configuration that is at least partially complimentarily shaped to match the concave arcuate surface of the litter receptacle.

### CROSS-REFERENCE TO RELATED APPLICATION/PRIORITY CLAIM

The present application claims benefit of U.S. Provisional Application No. 62/260,303, filed Nov. 26, 2015.

### TECHNICAL FIELD

The present disclosure relates to litter bowls and scoops used to remove dirty litter, urine clumps and feces of cats and the like. More specifically, the present disclosure relates to a litter bowl and scoop with improved geometry to facilitate the efficient removal of dirty litter, urine clumps and feces of cats and the like.

### BACKGROUND

Litter boxes and the like are well known for use in homes to give pet cats a sanitary means of performing various bodily functions. These litter boxes are typically outfitted with a scoop or other device that allows dirty litter, urine clumps and feces to be removed in a sanitary manner. However, known designs for litter boxes suffer from various deficiencies.

For example, it is often difficult to get the dirty litter, urine clumps and feces out of the litter box efficiently and effectively. Scoops often break up the urine clumps or fail to scoop up all of the dirty litter and feces the first time. To remedy this problem, the user often has to make repeated attempts to remove the remaining dirty litter, urine clumps and feces. This leads to lost time and user frustration.

Most of the time, the user may fail to make those repeated attempts to remove all the dirty litter, urine clumps and feces due to a lack of time or desire. As a result, the refuse may stay within the litter box a prolonged period of time, leading to an unwanted odor emanating from the litter box. Also, the refuse may cling to and/or be compressed over time in the litter box, making it more difficult to remove The useful life of the litter may become diminished and the user may have to eventually discard all the contents of the litter box because the litter box has become unsanitary. In fact, some cats will cease to use the litter box, creating problems elsewhere in the home. This leads to increased user frustration or cost.

Some known attempted solutions to these problems include the use of automated litter box cleaning devices. However, these attempted solutions are expensive and may require some maintenance of their own such as the changing of batteries, replacing worn parts, removing and cleaning the scooping apparatus and then reattaching the scooping apparatus, etc. Furthermore, the cat may inadvertently trigger the movement of the scooping apparatus, spooking the cat from wanting to use the litter box in the future, which can lead to other sanitary problems elsewhere in the home.

Consequently, there is a need for a litter receptacle and waste removal device that is more efficient, less expensive, and more convenient to use than has yet been devised in the art.

### SUMMARY OF THE DISCLOSURE

A litter receptacle assembly is provided comprising a litter receptacle including a concave arcuate surface and a litter scoop including a scoop portion and a handle portion, wherein the scoop portion includes a bottom wall including a front scoop edge having a convex arcuate configuration that is at least partially complimentarily shaped to match the concave arcuate surface of the litter receptacle.

A litter scoop is provided comprising a scoop portion including a bottom wall with a front scoop edge having a convex radial configuration, the bottom wall also including a bottom surface having a spherical radial configuration and a handle portion extending from the scoop portion.

A litter receptacle assembly is provided comprising at least a litter bowl including a generally cylindrical configuration defining a radial direction and a cylindrical axis. The litter bowl comprises a top annular wall, a concave arcuate wall that includes a concave arcuate surface with a continuous spherical radius, and a bottom axial extremity defined by the radius. A radially inside cylindrical wall connects the top annular wall to the concave arcuate wall and a radially outside cylindrical wall extends down from the top annular wall along the cylindrical axis at least to the axial extremity of the concave arcuate wall.

### BRIEF DESCRIPTION OF THE DRAWINGS

FIG. 1 is a top oriented perspective view of a litter receptacle having an arcuate configuration such as a round or bowl configuration according to an embodiment of the present disclosure.

FIG. 2 is a bottom oriented perspective view of the litter receptacle of FIG. 1, illustrating how the bottom of the receptacle is hollow to maintain the nominal wall thickness of the receptacle.

FIG. 3 is sectional view of the litter receptacle of FIG. 1 taken along lines 3-3 thereof.

FIG. 4 is a top view of a litter receptacle having a square shape according to another embodiment of the present disclosure.

FIG. 5 is a sectional view of the litter receptacle of FIG. 4 taken along lines 5-5 thereof.

FIG. 6 is a perspective view of a litter scoop according to an embodiment of the present disclosure.

FIG. 7 is an enlarged side view of the litter scoop of FIG. 6, better illustrating its arcuate configured bottom surface.

FIG. 8 is a top view of a litter scoop according to another embodiment of the present disclosure.

FIG. 9 is a side view of the litter scoop of FIG. 8.

FIG. 10 is a front view of the litter scoop of FIG. 8.

FIG. 11 is a perspective view of a litter scoop according to a third embodiment of the present disclosure.

FIG. 12 is a front view of the litter scoop of FIG. 11.

FIG. 13 is a perspective view of a litter scoop according to a fourth embodiment of the present disclosure.

FIG. 14 is a front view of a cover for use with a litter receptacle according to an embodiment of the present disclosure.

FIG. 15 is a perspective view of a mat for use with a litter receptacle according to an embodiment of the present disclosure.

FIG. 16 is an enlarged perspective view of the mat of FIG. 15.

FIG. 17 is an enlarged side view of the mat of FIG. 15.

FIG. 18 is an exploded assembly view of a litter receptacle assembly according to an embodiment of the present disclosure including the cover of FIG. 14, the scoop of FIG. 6, the litter receptacle of FIG. 1, and the mat of FIG. 15.

FIG. 19 is a perspective view of a litter receptacle assembly according to another embodiment of the present disclosure shown fully assembled including an alternate embodiment of the cover and receptacle used with the scoop of FIG. 13.

FIG. 20 is a sectional view of the assembly of FIG. 19 taken along lines 20-20 thereof.

FIGS. 21-23 illustrate a third embodiment of a litter receptacle assembly including a revised cover design.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or a prime indicator such as 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters or primes will often not be included herein but may be shown in the drawings to indicate duplications of features discussed within this written specification.

This disclosure describes various embodiments of a litter receptacle that has no vertices or edges that may trap refuse or dirty litter, unlike previously known designs of litter receptacles. In some embodiments, the litter receptacle is formed having a continuous spherical radius. The litter scoop may be designed with a matching leading edge radius so when pushed through the litter at any starting point it will make a clean pass effectively extending the useful life of the litter. In some embodiments, the bottom surface of the litter scoop shares the same radius as the litter receptacle as well.

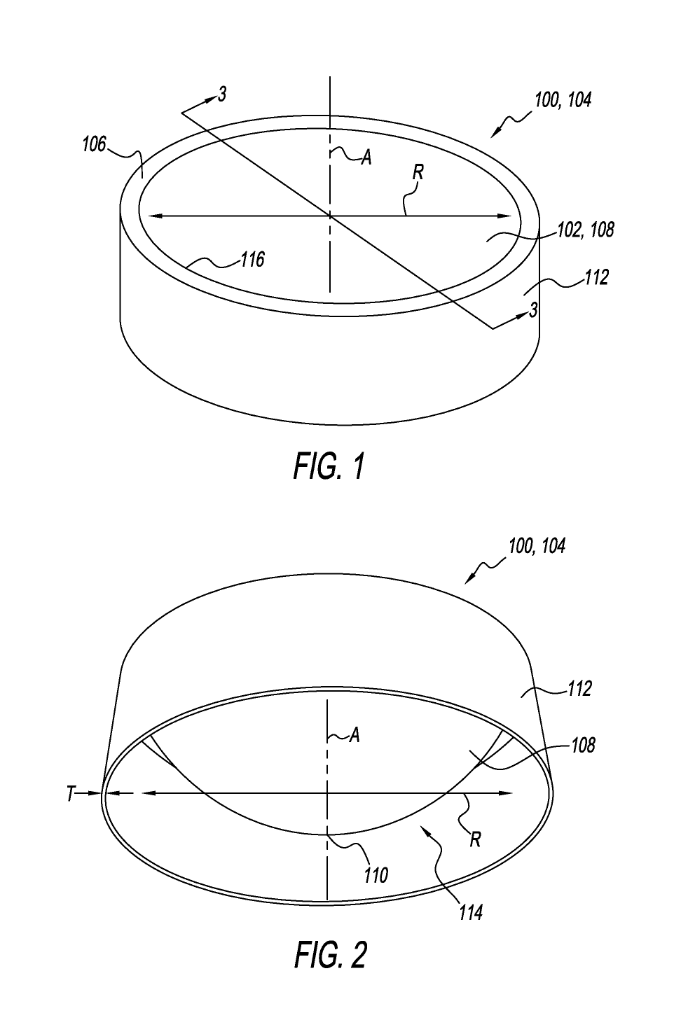

Looking at FIGS. 1-3, a litter receptacle according to a first embodiment of the present disclosure is illustrated. The litter receptacle 100 includes a concave arcuate surface 102 to hold litter and the like. For this particular embodiment, the litter receptacle 100 includes a cylindrical bowl configuration, defining a radial direction R and a cylindrical axis A. Accordingly, this litter receptacle may be referred to as a litter bowl 104. The litter receptacle 100 includes a top annular wall 106, a concave arcuate wall 108 that includes the concave arcuate surface 102 and a bottom axial extremity 110, and an outside cylindrical wall 112 that extends down from the top annular wall 106 along the axis A at least to the axial extremity 110 of the concave arcuate wall 108. In some instances, this wall 112 would extend past the axial extremity 110 of the concave arcuate wall 108 so that a flat surface is provided by the wall for the litter receptacle to sit on to avoid wobbling of the litter receptacle on a flat surface. For this embodiment, the concave arcuate surface 102 extends directly from the top annular wall 1061. This may not be the case in other embodiments.

As best seen in FIG. 2, the litter receptacle 100 includes a hollow bottom portion 114. This allows the litter receptacle 100 to maintain a relatively consistent nominal wall thickness T. This is desirable when manufacturing the litter receptacle using a plastic injection molding process as this helps the litter receptacle to be free of sinks and voids, which are molding problems associated with thick wall sections.

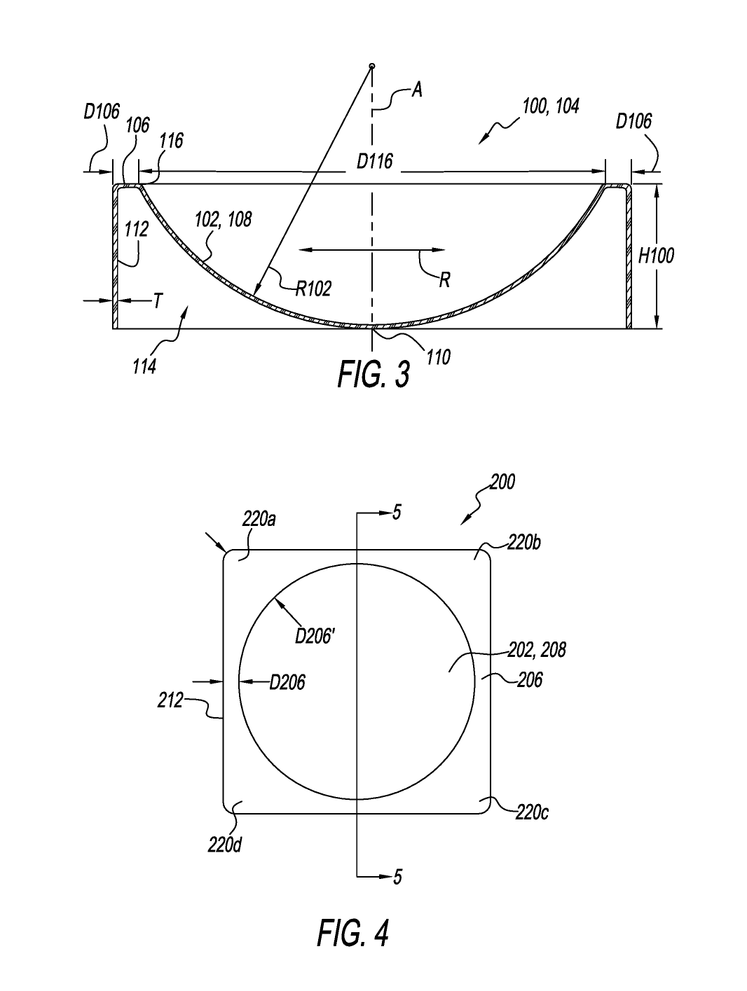

Looking at FIG. 3, various dimensions of the litter receptacle 100 are shown. The intersection of the top annular wall 106 with the concave arcuate surface 102 defines a circle 116 that may have a diameter D116 that ranges from 18-22 inches and may be 20 inches in some embodiments. The radial dimension D106 of the top annular wall 106 is also shown and is consistent about the perimeter of the litter receptacle 100. This radial dimension D106 may range from 0.5-1.5 inches and may be one inch in certain embodiments. Finally, the overall height H100 along the cylindrical axis A and the radius of curvature R102 for the arcuate surface 102 are also depicted. The overall height D106 may range from 4-8 inches and may be 6 inches in some embodiments. The radius of curvature R102 may range from 8-20 inches and may be 11.4375 inches in certain embodiments. It is to be understood that any of these dimensions may be varied as needed or desired in other embodiments. For this embodiment, the radius of curvature is a spherical radius but it is contemplated that other arcuate shapes with an inconsistent radius of curvature may be used in other embodiments.

It should be noted that small radii typically exist between larger surfaces to provide a gradual transition. For practical purposes, any of the embodiments discussed herein for any component including a litter scoop and a litter receptacle are to be understood to be present but will be ignored in terms of discussion within this written specification for the sake of brevity as these radii have a small effect on the function of the various embodiments of the present disclosure.

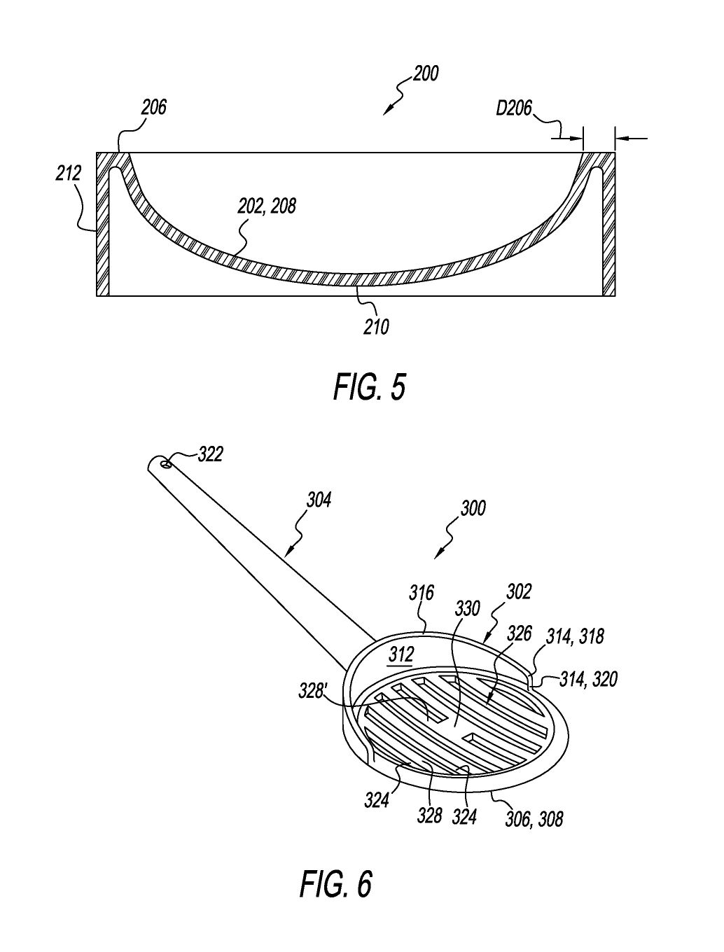

Turning now to FIGS. 4 and 5, a second embodiment of a litter receptacle of the present disclosure is shown. This litter receptacle 200 is similarly configured as the embodiment illustrated in FIGS. 1-3, except for the following differences. First, this litter receptacle 200 includes a square or rectangular configuration that defines four corners 220. Consequently, the radial dimension D206 of the top wall 206 varies from its smallest dimension, which corresponds to the radial dimension D106 of the top annular wall 106 of FIG. 3, to its thickest dimension D206′ at the corners 220. Secondly, as best understood with reference to FIG. 5, the outer wall 212 clearly extends past the bottom axial extremity 210 of the concave arcuate wall 208 that includes the concave arcuate surface 202. Other than this small difference, the dimensions of the features of FIG. 5 may be identical to those of FIG. 3. Other configurations such as any sort of polygonal shape are also considered to be within the scope of the present disclosure.

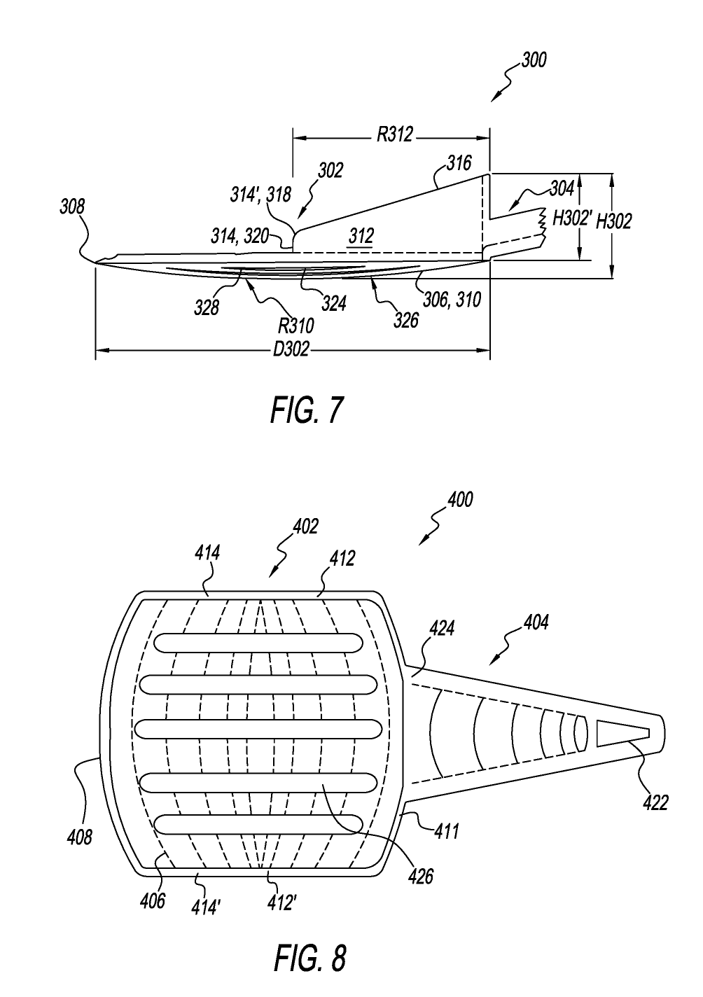

FIGS. 6 and 7 show a first embodiment of a litter scoop according to the present disclosure. The litter scoop 300 includes a scoop portion 302 and a handle portion 304, wherein the scoop portion 302 includes a bottom wall 306 including a front scoop edge 308 having a convex arcuate configuration that is at least partially complimentarily shaped to match the concave arcuate surface of the any of the litter receptacles discussed herein. The bottom wall 306 of the scoop portion 302 of the litter scoop 300 further comprises a bottom surface 310 that has a convex arcuate configuration that is at least partially complimentarily shaped to match the concave arcuate surface of any of the litter receptacles discussed herein.

The scoop portion 302 further includes a semi-circular sidewall 312 that connects to the bottom wall 306, forming a 180 degree perimeter that forms a partial enclosure of the scoop portion 302. At least one transitional surface 314 connects the bottom wall 310 to the sidewall 312. In many embodiments, each of these transitional surfaces includes either a straight segment or an arcuate segment. For the embodiment shown in FIGS. 6 and 7, an angled straight segment 316 least to a small radius 318 that then leads to a downward extending surface 320. The scoop portion 302 may be characterized as having a generally circular configuration. The handle 304 is shown to include an aperture 322 for hanging the scoop on a hook or the like.

FIG. 6 shows that the bottom wall 306 of the scoop portion 302 defines a plurality of elongated slots 324, forming a grate pattern 326 on the scoop portion 302 including an alternating series of ribs 328 separated by the elongated slots 324. A central hub portion 330 may be provided that interconnects two of these ribs 328 near the center of the scoop portion 302. This feature may be omitted in other embodiments. The sidewall 312 is shown to lack a grate pattern, but a grate pattern may be provided on this sidewall in other embodiments.

Focusing now on FIG. 7, various dimensions of this litter scoop 300 are illustrated. Specifically, the overall maximum height H302 of the scoop portion 302, the minimum height H302′ of the scoop portion 302, the diameter D302 of the scoop portion 302 and the radius R312 of the semi-circular sidewall 312, and the radius of curvature R310 of the bottom surface 310 of the scoop portion 302 are illustrated. For this embodiment, the radius of curvature R310 of the bottom surface 310 is a spherical radius and the front edge 308 of the scoop portion 302 shares the same radius of curvature. The diameter D302 of the scoop portion may range from 3-5 inches and may be 4 inches. The overall maximum height H302 of the scoop portion may range from 0.75 to 1.25 inches and may be one inch while the minimum height H302′ may be approximately 0.125 inches less than H302. The radius R312 of the semi-circular sidewall 312 may range from 1.5-2.5 inches and may be 2 inches. The radius of curvature R310 of the bottom surface 310 of the scoop portion 302 may range from 8-20 inches and may be 11.4375 inches. Any of these dimensions may be varied as needed or desired.

A second embodiment of a litter scoop is contained in FIGS. 8-10. This litter scoop 400 comprises a scoop portion 402 including a bottom wall 406 with a front scoop edge 408 having a convex radial configuration, the bottom wall 406 also including a bottom surface 410 having a spherical radial configuration, and a handle portion 404 extending from the scoop portion 402 that defines an aperture 422 for hanging the scoop. The spherical radial configuration of the bottom wall 406 extends directly from the front scoop edge 408, sharing the same radius of curvature. A back wall 411 and two sidewalls 412 extend from the bottom wall 406 to form a three sided partial enclosure of the scoop portion 402. The back wall 411 is shown to have a circular configuration but the back wall may be straight in other embodiments. A grate pattern 432 is formed on the sidewalls 412 that includes two elongated slots 424. The sidewalls 412 extend from the back wall 411 all the way to the front scoop edge 408. A transitional surface 414 extends from the back wall 411 to the front edge 408 in the form of an arcuate segment, such as a radius.

A grate pattern 426 is also formed on the bottom wall 406 of the scoop portion 402 without a central hub. The handle portion 404 extends rearwardly from the back wall 411 in a straight manner, sharing the same top surface 424. As best seen in FIG. 8, the scoop portion 402 includes a partially square or rectangular configuration.

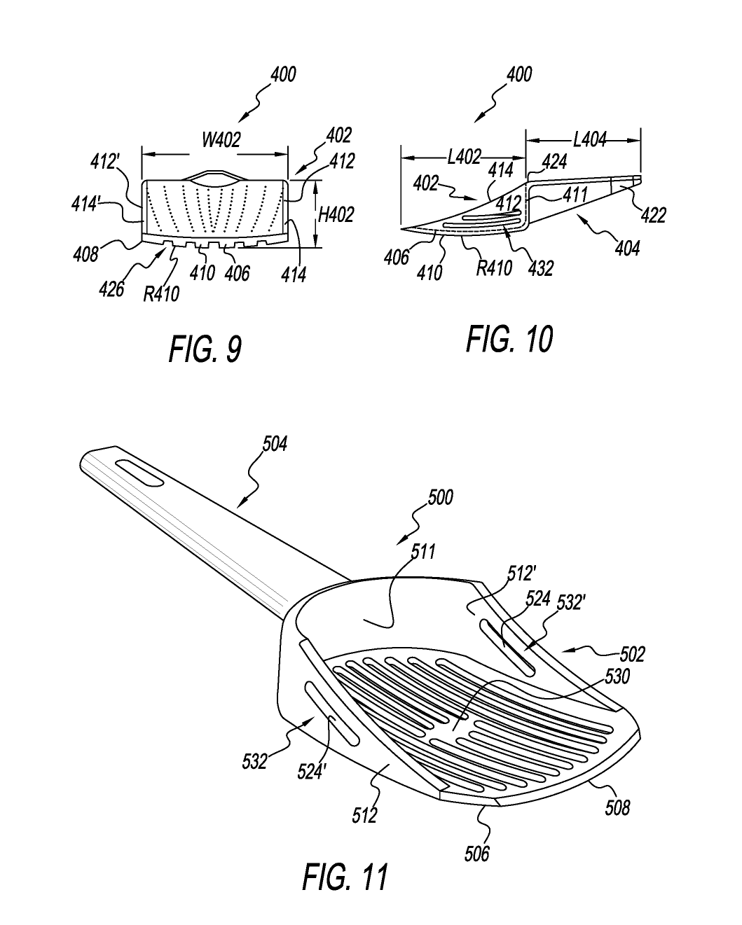

FIGS. 9 and 10 show various dimensions of this litter scoop 400. FIG. 9 shows the overall height H402 of the scoop portion 402 and the width W402 of the scoop portion 402. FIGS. 9 and 10 show the spherical radius of curvature R410 of the bottom surface 410 of the bottom wall 406. Finally, FIG. 10 shows the length L404 of the handle portion 404 and the length L402 of the scoop portion 402. The height H402 of the scoop portion 402 may be approximately 2 inches while its width W402 may be approximately 4 inches. The length L404 of the handle 404 may be approximately 4 inches and the length L402 of the scoop portion 402 may also be approximately 4 inches. The length L404 of the handle 404 may exceed the length L402 of the scoop portion 402 in other embodiments such as by a factor of 3. The radius of curvature R410 of the bottom surface 410 may range from 8-20 inches and may be 11.4375 inches in some embodiments. Any of these dimensions may be altered as needed or desired in other embodiments.

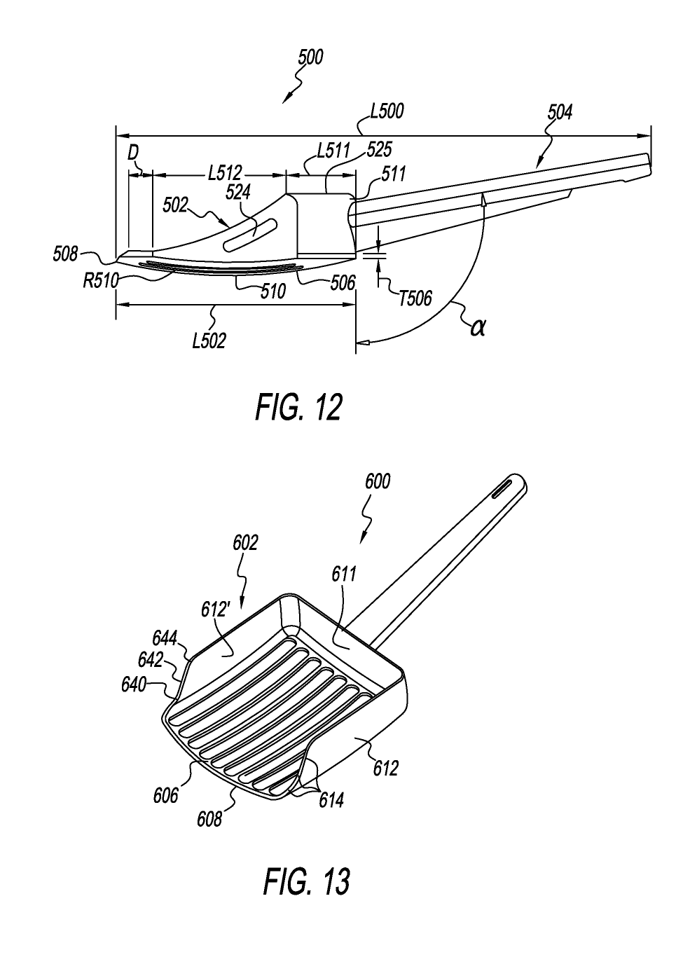

Looking now at FIGS. 11 and 12, a third embodiment of a litter scoop will now be described. This litter scoop 500 is similarly configured as the scoop of FIGS. 8-10, except for some slight differences as will now be described. A central hub 530 is provided at the center for grate pattern 526 of the bottom wall 506. Only one elongated slot 524 is shown on the sidewalls 512. Also, the sidewalls 512 terminate a predetermined distance away from the front scoop edge 508 of the scoop portion 502. The handle portion 504 extends at an angle α from the back wall 511 and does not share the same top surface 525 as the back wall 511. That is to say, the handle 504 extends from the back wall 511 a predetermined distance away from the top surface 525.

FIG. 12 shows various dimensions of this embodiment of a litter scoop 500. Specifically, the length L502 of the scoop portion 502, the length L511 of extension of the back wall 511 toward the front scoop edge 508, the length L512 of the sidewall 512, the distance D from the sidewall 512 to the front edge 508, the thickness T506 of the bottom wall 506, the overall length L500 of the scoop, and the angle α the handle extends from the back wall 511 are shown. For this embodiment, exemplary values for these dimensions will now be given. The length L502 of the scoop portion may be 5.5 inches, the length L511 of the extension of the back wall 511 may be 1.625 inches, the length L512 of the sidewall 512 may be 3 inches, and the distance D from the sidewall 512 to the front edge 508 may 0.625 inches. The thickness T506 of the bottom wall 506 may be 0.125 inches, the overall length L500 of the scoop 500 may be approximately a foot long, and the angle α the handle 504 extends from the back wall 511 may be approximately 100 degrees. Any of these dimensions may be varied as needed or desired in other embodiments.

As with previous embodiments, the radius of curvature R510 of the bottom surface 510 may be the same as that of the front edge 508 and may range as needed or desired but may be approximately 11.4375 inches in certain embodiments.

A fourth embodiment of a litter scoop is illustrated by FIG. 13. This litter scoop 600 is similarly configured as the litter scoop of FIGS. 11 and 12 except for some differences that will now be described. There is no central hub disposed at the center of the grate pattern 626 of the bottom wall 606 of the scoop portion 602. The back wall 611 is straight instead of curved. Also, the sidewalls 612 extend all the way from the back wall 611 to the front scoop edge 608. Transition surfaces 614 extend from the front edge 608 to the top of the sidewall 612 and include a convex radius 640, a straight segment 642 and a concave radius 644.

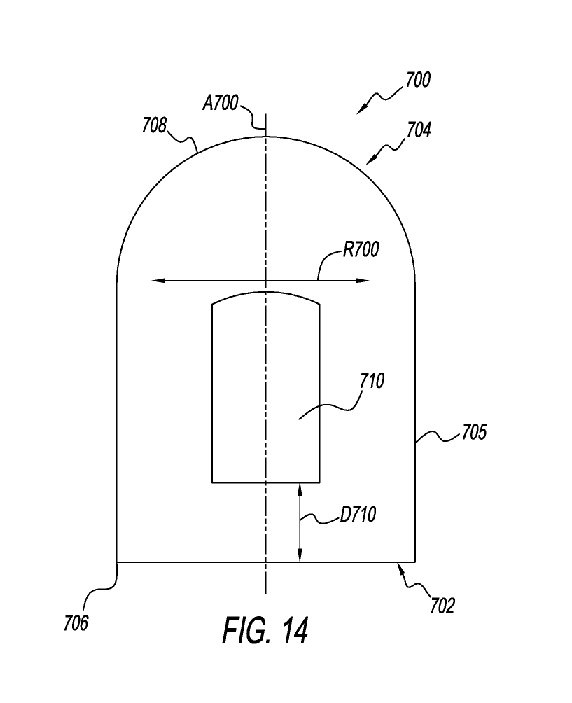

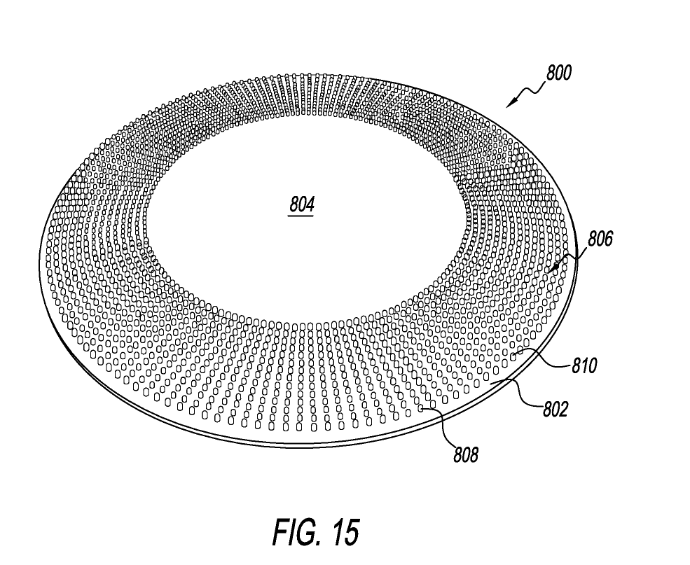

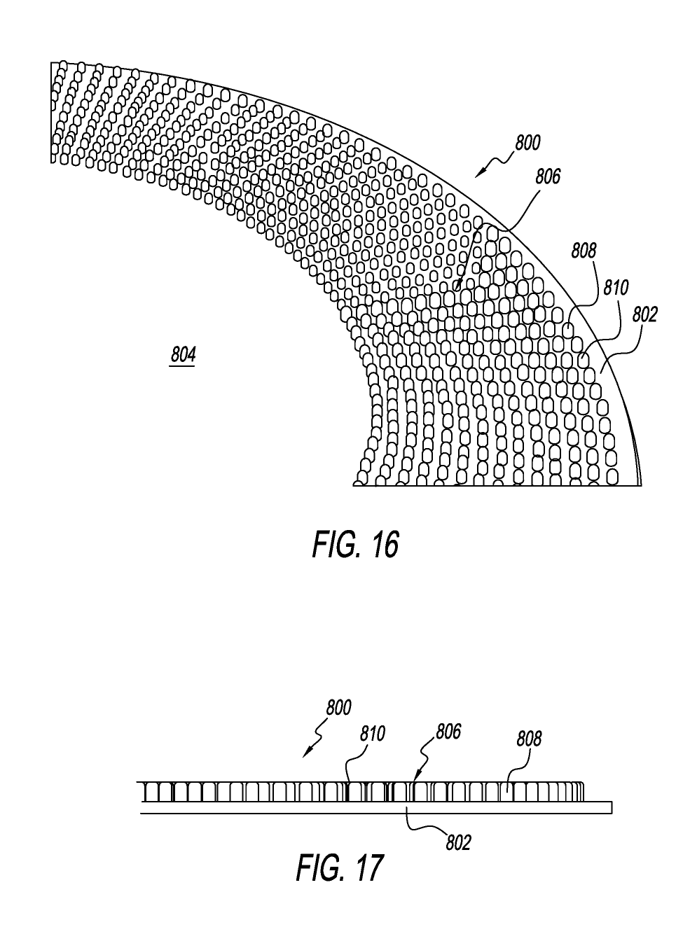

Thus far, various embodiments of a litter receptacle and a litter scoop have been described. The receptacle and the scoop are typically used together. Optional components will now be described that may be used together with a receptacle and a scoop. Particularly, FIG. 14 is a front view of a cover that may go over a litter receptacle while FIGS. 15-17 show a mat that may go underneath a litter receptacle if so desired.

The cover 700 in FIG. 14 has a generally cylindrical configuration defining a radial direction R700 and a cylindrical axis A700. The cover 700 includes an open end 702 and an enclosed end 704. A cylindrical wall 705 with a free end 706 defines the open end 702 while a domed wall 708 defines the enclosed end 704. The cover 700 further defines an opening 710 spaced away a predetermined distance D710 from the free end 706 of the cylindrical wall 705 measured along the cylindrical axis A700. This opening 710 is configured to allow a cat to enter and exit the cover 700 to access the litter receptacle when the cover 700 is placed over the receptacle. Other configurations of the cover 700 are possible to match the various embodiments of the litter receptacle including those having a square, rectangular, or polygonal perimeter, etc.

FIGS. 15-17 illustrate a mat 800 that includes a body 802 having a center portion 804 and a peripheral portion 806, wherein the center portion 804 is flat and is configured for the litter receptacle to rest only on the center portion 804. The peripheral portion 806 includes a plurality of standoffs 808 projecting from the body 802. These standoffs 808 may effectively remove litter from the paws of a cat as the cat exits the litter receptacle. To that end, the standoffs 808 may have a generally cylindrical shape with rounded ends 810 that comfortably conform to and brush off the litter from the paws of the cat. While a circular configuration for the mat 800 is shown, other configurations are possible in order to match the various configurations of the cover and the litter receptacle.

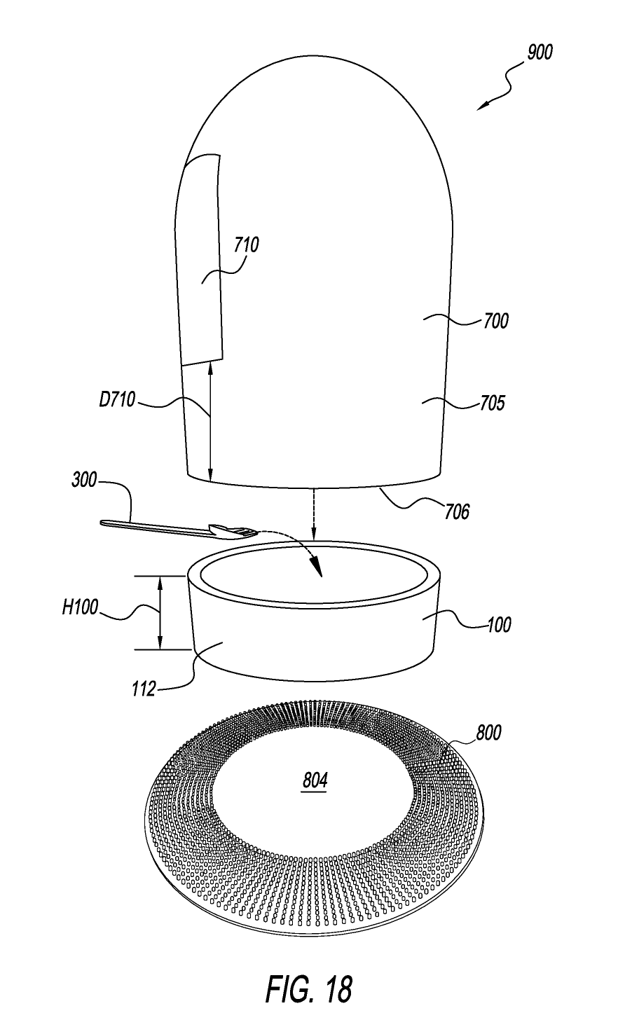

FIG. 18 is an exploded assembly view of a litter receptacle assembly 900 according to an embodiment of the present disclosure including the cover 700 of FIG. 14, the scoop 300 of FIG. 6, the litter receptacle 100 of FIG. 1, and the mat 800 of FIG. 15. As alluded to previously, the receptacle 100 would sit on the center portion 804 of the mat 800 and the cover 900 would go over and around the receptacle 100, sitting on the center portion 804 of the mat 800. As mentioned previously, the litter receptacle 100 defines a height H100 that is less than the predetermined distance D710 the opening 710 of the cover 700 is spaced away from the free end 706 of the cylindrical wall 705. So, as a cat enters through the opening 710, the cat may enter the litter containing portion of the receptacle 100 without tripping over its radially outer cylindrical wall 112. Alternatively, the cover may sit on the receptacle in other embodiments as will now be described.

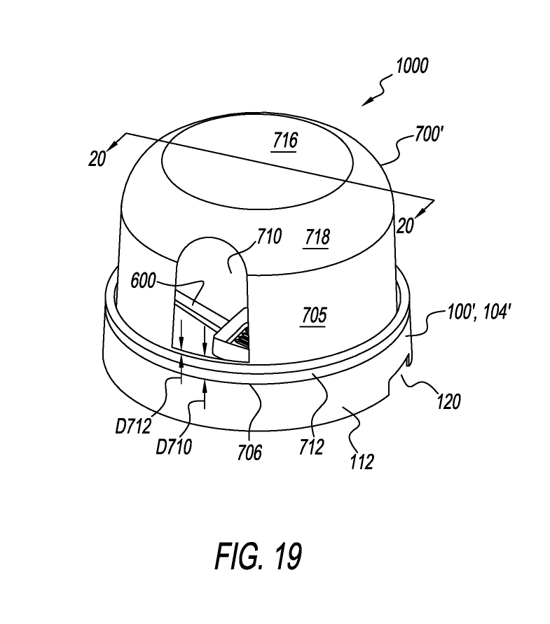

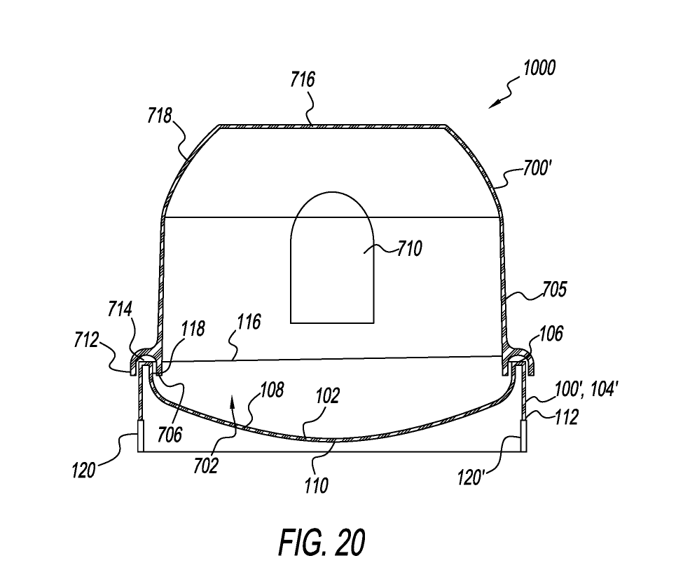

FIG. 19 is a perspective view of a litter receptacle assembly 1000 according to another embodiment of the present disclosure shown fully assembled including an alternate embodiment of the cover 700′ and receptacle 100′ used with the scoop 600 of FIG. 13. FIG. 20 is a sectional view of the assembly 1000 of FIG. 19 with the scoop removed for enhanced clarity. A mat is not included with this assembly but it is contemplated one may be supplied if so desired.

This cover 700′ further comprises a flange 712 that extends from cylindrical sidewall 705 above the free end 706 of the sidewall 705. A recess 714 is defined radially between the flange 712 and the cylindrical wall 705. This recess 714 is configured to receive the litter receptacle 100′. The cover 700′ has a generally cylindrical configuration defining a radial direction and a cylindrical axis (see FIG. 14). The cover 700′ includes a cylindrical wall 705 with a free end 706, a top wall 716, and a transitional wall 718 that connects the cylindrical wall 705 to the top wall 716, the cover 700′ including an open end 702 defined by the free end 706 of the cylindrical wall 705. The cover further defines an opening 710 spaced away a predetermined distance D710 from the free end 706 of the cylindrical wall 705 measured along the cylindrical axis. Also, the opening 710 is spaced away a distance D712 from the flange 712 along the cylindrical axis.

Looking at the receptacle 100′ or bowl 104′ of FIGS. 19 and 20, it comprises a generally cylindrical configuration defining a radial direction and a cylindrical axis (shown in FIGS. 1-3). The litter bowl 104′ comprises a top annular wall 106, a concave arcuate wall 108 that includes a concave arcuate surface 102, a bottom axial extremity 110 and a radially inside cylindrical wall 118 that connects the top annular wall 106 to the concave arcuate wall 108. A radially outside cylindrical wall extends down from the top annular wall 106 along the cylindrical axis at least to the axial extremity 110 of the concave arcuate wall 108. The intersection of the radially inside cylindrical wall 118 with the concave arcuate wall 108 defines a circle 116 having a diameter that may range from 18-22 inches. Also, the radially outside cylindrical wall 112 defines a first slot 120 and a second slot 120′ (not shown in FIG. 19) that are positioned diametrically opposite each other. A user may use these slots to lift the receptacle when needed such as when it is desired to dump the litter out of the receptacle.

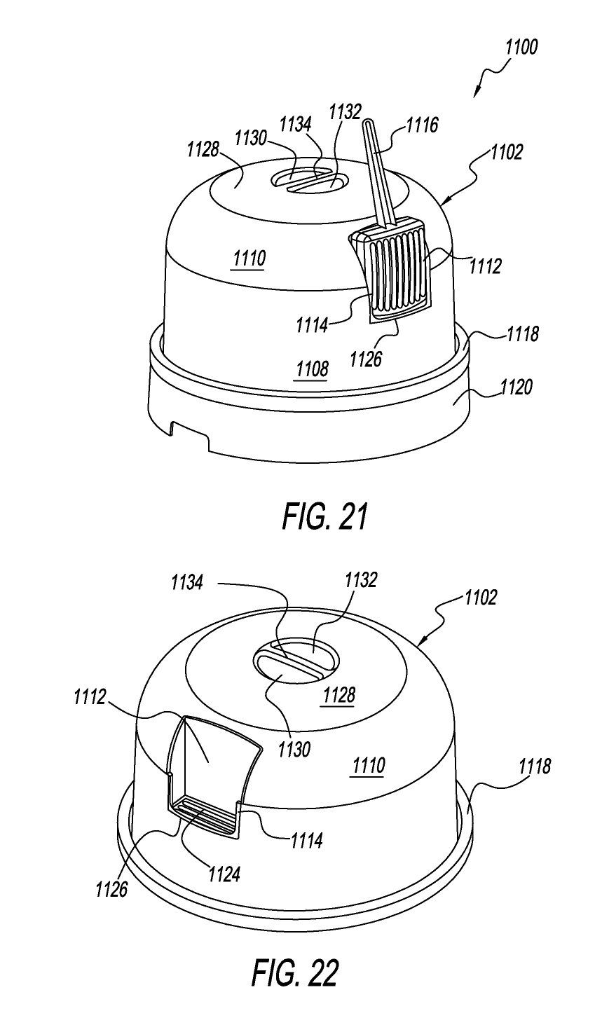

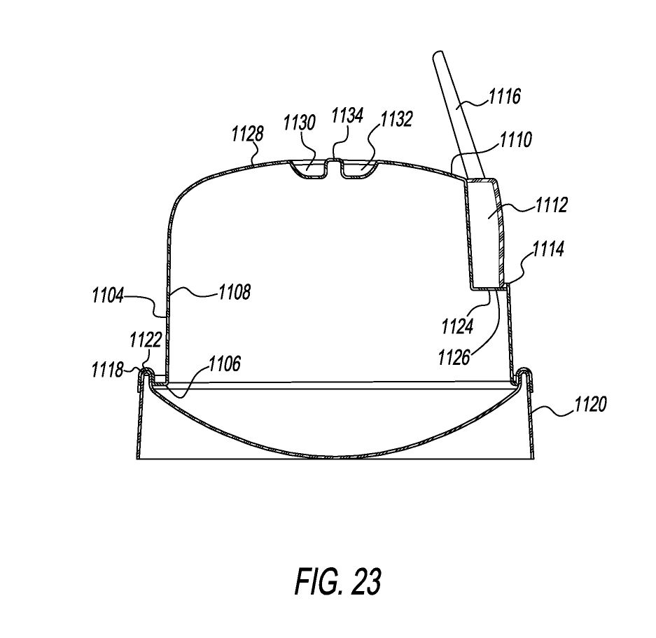

FIGS. 21-23 illustrate a third embodiment of a litter receptacle assembly. This assembly 1100 is similarly configured as the assembly of FIGS. 19 and 20 except for the following differences. For example, the cover 1102 defines an opening 1104 adjacent the free end 1106 of the cylindrical wall 1108 measured along the cylindrical axis extending almost all the way to the free end 1106 of the cylindrical wall 1108. Also, the cylindrical wall 1108 and the transitional wall 1110 define a pocket 1112 with a ledge 1114 that is configured to receive and store a litter scoop 1116. Furthermore, the cover 1102 further includes a flange 1118 that extends from the bottom of the cylindrical sidewall 1108, the flange 1118 being configured to receive a portion of the litter bowl 1120. The flange 1118 extends from the bottom of the cylindrical wall 1108 of the cover 1102 in a serpentine manner, defining a recess 1122 that is configured to receive the bowl 1120. A grate pattern 1124 is defined by the bottom wall 1126 of the pocket 1112 to allow litter to fall from the scoop back into the bowl. The top wall 1128 jogs downwardly and then upwardly, forming a first depression 1130 in the top wall. The top wall then jogs once more downwardly and then upwardly, forming a second depression 1132 in the top wall. This results in a handle portion 1134 being defined between the depressions by the top wall, which a user can hold onto to take the cover off the receptacle bowl or place the cover back onto the receptacle bowl.

### INDUSTRIAL APPLICABILITY

In practice, a litter receptacle assembly, litter receptacle or bowl, litter scoop, cover and mat may be manufactured, sold, bought or otherwise obtained according to any of the embodiments as described herein. In some cases, the litter receptacle, mat, cover and scoop may be sold separately as a replacement part. In some instances, one or more of components may be sold together.

The components described herein including the litter receptacle and the litter scoop may be made using a plastic injection molding process. The components may be molded of any suitable material such as a thermoplastic material that is easily molded and that can provide the end properties needed or desired for any particular application. In some embodiments, the material used may be polycarbonate, high density polyethylene, etc.

It is further contemplated that any of the components described herein that are made from a single unitary molded component could be separated into multiple components that are assembled together.

Due to the continuous spherical radius provided on the bottom surface of the scoop to the front scoop edge, and the complimentarily continuous radius provided on the litter receptacle or bowl, the user may effectively and efficiently remove dirty litter regardless of the area of placement of the scoop within the receptacle or its angular orientation relative to the litter bearing surface of the receptacle or bowl. Also, there are no corners, vertices, edges or nooks in which dirty litter may become compressed or stuck. Accordingly, the risk of fouling the litter requiring replacement of all the litter in the receptacle or bowl is diminished.

It is further contemplated that electronic devices used in “invisible fencing” type systems or the like, which limit where a dog roams, may also be used with the cover or litter receptacle to help prevent a dog from tampering with the litter receptacle assembly. For example, the perimeter of the open ends of the cover and/or the receptacle may be embedded with transmitters that send a signal to a dog collar when the dog approaches these perimeters too closely. Similarly, the perimeter of the opening on the side of the cover may also be embedded with such transmitters.

Reference is made herein to cylindrical walls. It is to be understood that most walls referred to as cylindrical have a draft angle, making them technically slightly conical. Accordingly, any wall or surface that has a draft angle of 10 degrees or less as described within this disclosure or its associated figures is to be considered to by cylindrical.

It will be appreciated that the foregoing description provides examples of the disclosed assembly and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A litter receptacle assembly comprising:
a litter receptacle including a concave arcuate surface; and
a litter scoop including a scoop portion and a handle portion, wherein the scoop portion includes a bottom wall including a front scoop edge having a convex arcuate configuration that is at least partially complimentarily shaped to match the concave arcuate surface of the litter receptacle.

2. The litter receptacle assembly of claim 1 wherein the bottom wall of the scoop portion of the litter scoop further comprises a bottom surface that has a convex arcuate configuration that is at least partially complimentarily shaped to match the concave arcuate surface of the litter receptacle.

3. The litter receptacle assembly of claim 1 wherein the scoop portion includes a sidewall that extends from the bottom wall, forming a partial enclosure of the scoop portion.

4. The litter receptacle assembly of claim 3 the scoop portion further including at least one transitional surface that connects the front scoop edge to the first sidewall and a second transitional surface that connect the front scoop edge to the second sidewall.

5. The litter receptacle assembly of claim 4 wherein each of the transitional surfaces includes either a straight segment or an arcuate segment.

6. The litter receptacle assembly of claim 1 wherein the litter receptacle includes a cylindrical bowl configuration, defining a radial direction and a cylindrical axis.

7. The litter receptacle assembly of claim 6 wherein the litter receptacle includes a top annular wall, a concave arcuate wall that includes the concave arcuate surface and a bottom axial extremity, an inside cylindrical wall that connects the top annular wall to the concave arcuate wall, and an outside cylindrical wall that extends down from the top annular wall at least to the axial extremity of the concave arcuate wall.

8. The litter receptacle assembly of claim 6 wherein the litter receptacle includes a hollow bottom portion.

9. The litter receptacle assembly of claim 1 further comprising a cover having a generally cylindrical configuration defining a radial direction and a cylindrical axis, the cover including a cylindrical wall with a free end, a top wall, and a transitional wall that connects the cylindrical wall to the top wall, the cover including an open end defined by the free end of the cylindrical wall, the cover further defining an opening spaced way a predetermined distance from the free end of the cylindrical wall measured along the cylindrical axis.

10. The litter receptacle assembly of claim 9 wherein the litter receptacle defines a height that is less than the predetermined distance the opening of the cover is spaced away from the free end of the cylindrical wall.

11. The litter receptacle assembly of claim 9 wherein the cover further comprises a flange that extends from cylindrical sidewall above the free end of the sidewall, the flange defining a recess radially between the flange and the cylindrical wall that is configured to receive the litter receptacle.

12. The litter receptacle assembly of claim 11 wherein the opening is spaced away from the flange along the cylindrical axis.

13. The litter receptacle assembly of claim 1 further comprising a mat that includes a center portion and a peripheral portion, wherein the center portion is flat and is configured for the litter receptacle to rest only on the center portion, and the peripheral portion includes a plurality of standoffs.

14. A litter scoop comprising:
a scoop portion including a bottom wall with a front scoop edge having a convex radial configuration, the bottom wall also including a bottom surface having a spherical radial configuration; and
a handle portion extending from the scoop portion.

15. The litter scoop of claim 14 wherein the spherical radial configuration of the bottom wall extends directly from the front scoop edge, sharing the same radius of curvature that ranges from 8-20 inches.

16. A litter receptacle assembly comprising:
at least a litter bowl including a generally cylindrical configuration defining a radial direction and a cylindrical axis, the litter bowl comprising:
a top annular wall, a concave arcuate wall that includes a concave arcuate surface with a continuous spherical radius, and a bottom axial extremity defined by the radius;
a radially inside cylindrical wall that connects the top annular wall to the concave arcuate wall; and
a radially outside cylindrical wall that extends down from the top annular wall along the cylindrical axis at least to the axial extremity of the concave arcuate wall.

17. The litter receptacle assembly of claim 16 wherein the intersection of the radially inside cylindrical wall with the concave arcuate wall defines a circle having a diameter that ranges from 18-22 inches.

18. The litter receptacle assembly of 16 wherein the radially outside cylindrical wall defines a first slot and a second slot that are positioned diametrically opposite each other.

19. The litter receptacle assembly of claim 16 further comprising a cover having a generally cylindrical configuration defining a radial direction and a cylindrical axis, the cover including a cylindrical wall with a free end, a top wall, and a transitional wall that connects the cylindrical wall to the top wall, the cover including an open end defined by the free end of the cylindrical wall, the cover further defining an opening adjacent the free end of the cylindrical wall measured along the cylindrical axis, wherein the cylindrical wall and the transitional wall define a pocket with a ledge.

20. The litter receptacle assembly of claim 19 wherein the cover further includes a flange that extends from the bottom of the cylindrical sidewall, the flange extending from the cylindrical sidewall in a serpentine manner forming a recess configured to receive a portion of the litter bowl.
